(19) United States
(12) Patent Application Publication
(10) Pub. No.: US 2007/0006655 A1
(43) Pub. Date: Jan. 11, 2007

(54) GLUE QUANTITY DETERMINATION

(75) Inventor: Helmut Voss, Lockstedt (DE)

Correspondence Address: GREENBLUM & BERNSTEIN, P.L.C., 1950 ROLAND CLARKE PLACE, RESTON, VA, 20191, US

(73) Assignee: HAUNI MASCHINENBAU AG, Hamburg (DE)

(21) Appl. No.: 11/464,120

(22) Filed: Aug. 11, 2006

Related U.S. Application Data
(63) Continuation of application No. PCT/EP05/01686, filed on Feb. 18, 2005.

(30) Foreign Application Priority Data
Feb. 27, 2004 (DE) 10 2004 010 120.5

(51) Int. Cl. G01N 29/04

(52) U.S. Cl. 73/602; 73/596

(57) ABSTRACT

Method and device for determining a quantity or mass of glue applied to a wrapping strip of the tobacco-processing industry, machine including the device and process. The method includes acting on the wrapping strip with ultrasound waves, receiving the ultrasound waves permeating through the wrapping strip as ultrasonic signals, and determining at least one of a quantity or mass of glue based on the ultrasonic signals received.

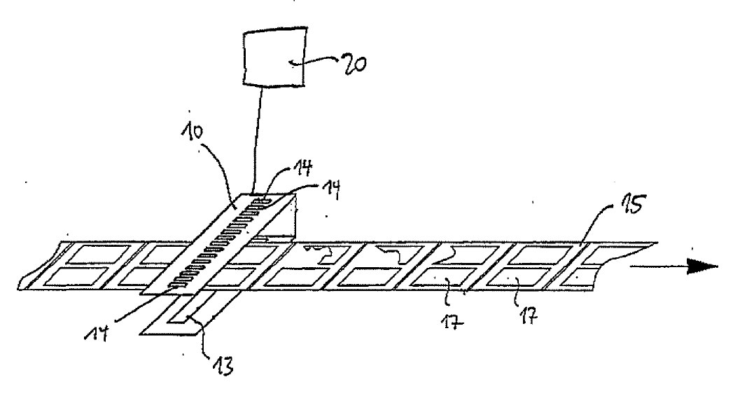

### CROSS-REFERENCE TO RELATED APPLICATIONS

The present application is a Continuation of International Patent Application No. PCT/EP2005001686 filed Feb. 18, 2005, and claims priority under 35 U.S.C. §119 of German Patent Application No. 10 2004 010 120.5, filed on Feb. 27, 2004. Moreover, the disclosure of International Patent Application No. PCT/EP2005001686 is expressly incorporated by reference herein in its entirety.

### BACKGROUND OF THE INVENTION

1. Field of the Invention

The invention relates to a method and a device for determining a quantity or mass of glue applied to a wrapping strip of the tobacco-processing industry. Moreover, the invention relates to a machine of the tobacco-processing industry and the use of a measuring system for determining a quantity or mass of glue applied to a wrapping strip of the tobacco-processing industry.

2. Discussion of Background Information

To join cigarette filters to cut tobacco rods, a tipping paper web is generally provided that wraps the filter and joins one top end of the cut tobacco rod to the filter with a projecting edge. The filter is generally joined to the cut tobacco rod by gluing.

European patent application EP-A-1 147 716 describes a device for applying glue to a wrapping material or a wrapping paper strip of a rod-shaped article of the tobacco-processing industry. In order to produce a glue pattern with areas free of glue on a wrapping strip, the device includes a device to interrupt the supply of glue to the wrapping paper strip.

At high production speeds on a filter tipping machine it can happen that the gluing layer on the tipping paper strip is applied too thinly or gaps or interruptions form due to process-related faults such as, e.g., contamination in the gluing system, so that no adequate connection is ensured between the filter and the out tobacco rod.

Moreover, sometimes it can become so that defective cigarettes are produced on the filter tipping machine that are not easy to detect in the further production process.

EP-B-0 418 342 describes a device for detecting sufficient moisture of the gluing of a paper strip, whereby the presence of a gluing on the paper strip to be glued is detected by a capacitive sensor.

### SUMMARY OF THE INVENTION

The present invention improves the determination of the quantity or mass of glue and the monitoring of a gluing on a wrapping strip of the tobacco-processing industry.

Accordingly, the present invention is directed to a method for determining a quantity or mass of glue applied to a wrapping strip of the tobacco-processing industry. According to the invention, the method provides that the wrapping strip is acted on with ultrasound, the sound waves permeating through the wrapping strip are received as ultrasonic signals, and the quantity or mass of glue is determined based on the ultrasonic signals received. Part of the ultrasonic waves emitted is absorbed by the glued paper and the part not absorbed is available as a measurement signal at the receiver sensor.

In contrast to the prior art, in which the moisture of a gluing on a wrapping strip is detected by a capacitive sensor, according to the invention the quantity of the glue applied is tested and monitored semicontinuously by ultrasound. A paper strip glued and conveyed at a high transport speed can hereby be tested for faulty areas in the gluing. The measurement process is a direct measurement process based on the quantity of glue applied and independent of the composition, e.g., the water content, of the glue. Moreover, vertical or horizontal paper fluctuations have hardly any negative impact on the ultrasound measurement signals received.

The capacitive measurement process known from the prior art is an indirect method, by the moisture content, i.e., the water content, of the glue is detected.

To implement the method, it is provided that the ultrasound is generated by at least one transmitter unit, in particular at least one piezoelectric element.

Furthermore, the ultrasound is received by at least one receiver unit, in particular at least one piezo-sensitive microphone.

In order to monitor the conveyed wrapping strip continuously, the wrapping strip is acted on with ultrasound transversely to the transport direction.

Furthermore, the wrapping strip can preferably be guided through or between the transmitter unit and sensor receiver unit. The ultrasound can thus be aligned to the wrapping strip with a preferred alignment and can permeate through the wrapping strip. Piezoelectric elements transmitting ultrasound are hereby arranged on the glued side of the wrapping strip or on the side uncoated with glue. The ultrasonic waves or signals are received on the other side by piezo-sensitive microphones or sensors.

In a preferred embodiment of the invention, the wrapping strip is monitored over its entire width. Thus, all widths of the wrapping strip can be detected format-free with the same measuring system, which comprises a transmitter unit and a sensor receiver unit.

Moreover, if the wrapping strip is acted on with ultrasound before the application of the glue, it is possible to eliminate fluctuations due to the thickness or the properties of the wrapping strip in the evaluation of the signals.

To this end, it is provided that the ultrasonic signals are compared with one another, in particular subtracted from one another, before the application of the glue pattern and after the application of the glue pattern. For this, the ultrasonic signals are preferably evaluated by an evaluation unit.

In order to be able to better recognize tendencies of the degree of gluing or of certain areas of the glue lines of the glue pattern, the ultrasonic signals are averaged in terms of time.

Moreover, it is advantageous if the quantity of glue of glue lines of a glue pattern is detected, preferably in time average, and/or defective areas of the glue pattern are recognzed based on the ultrasonic signals received.

Furthermore, the position of the wrapping strip and/or the cut position are recognized, in particular based on the ultrasonic signals received.

The invention is directed to a method for monitoring a glue pattern applied to a wrapping strip of the tobacco-processing industry. According to this method, the glue pattern is acted on with ultrasound, ultrasonic signals coming from the glue pattern are received, and that the glue pattern is monitored based on the ultrasonic signals received. Advantageous embodiments of this monitoring method for the glue pattern applied result according to the method according to the invention described above.

The invention is also directed to a device for determining a quantity or mass of glue applied to a wrapping strip of the tobacco-processing industry. The device includes an ultrasound measuring system provided with at least one source generating ultrasound for acting on the wrapping strip with ultrasound and with at least one ultrasound sensor receiver unit for receiving ultrasonic signals from the wrapping strip.

To this end, the wrapping strip is guided between the source generating the ultrasound and the ultrasound receiver unit.

According to an advantageous embodiment, the sensor unit is embodied to be U-shaped or fork-shaped.

At least one ultrasound source, in particular at least one piezoelectric element is thereby arranged on one branch of the U-shape, and at least one ultrasound sensor receiver unit, in particular at least one piezo-sensitive microphone, is arranged on the other branch of the U-shape. A greater number of piezoelectric elements emitting ultrasound is preferred, which elements are arranged in an array in order to obtain a homogenous sound field over the entire width of the wrapping strip. An array is also advantageous on the sensor receiver side, so that better local resolutions can be achieved.

In order to achieve a compensation of the paper thickness, a second, preferably U-shaped, sensor device with a source generating ultrasound and with an ultrasound receiver unit is provided before a glue application element for the wrapping strip, based on the transport direction of the wrapping strip.

Furthermore, it is advantageous if an evaluation device for evaluating the ultrasonic signals received is provided.

According to a further development, the device is further characterized in that the entire width of the wrapping strip can be monitored by the ultrasound measuring system.

Furthermore, the instant invention provides a device for monitoring a glue pattern applied to a wrapping strip of the tobacco-processing industry. The device includes a sensor device provided with at least one source generating ultrasound for acting on the glue pattern with ultrasound and at least one ultrasound receiver unit for receiving ultrasonic signals from the glue pattern. Advantageous further developments result accordingly for the embodiments for the detection device.

Furthermore, the invention provides a machine of the tobacco-processing industry equipped with a device according to the invention described above, in particular for determining a quantity or mass of glue applied to a wrapping strip of the tobacco-processing industry. To avoid repetition, reference is expressly made to the above statements on the device according to the invention.

The invention provides a use of a measuring system for determining a quantity or mass of glue applied to a wrapping strip of the tobacco-processing industry, in which the measuring system is embodied as an ultrasound measuring system.

To compensate for the paper properties or the paper thickness, furthermore a reference ultrasound measuring system is provided, preferably for the wrapping strip uncoated with glue.

it is also advantageous if an evaluation unit is provided for evaluating the ultrasonic signals received.

The ultrasound measuring system or the reference ultrasound measuring system operate according to the method shown above according to the invention, so that to avoid repetition reference is made to the statements above.

The present invention is directed to a method for determining at least one of a quantity or mass of glue applied to a wrapping strip of the tobacco-processing industry. The method includes acting on the wrapping strip with ultrasound waves, receiving the ultrasound waves permeating through the wrapping strip as ultrasonic signals, and determining at least one of a quantity or mass of glue based on the ultrasonic signals received.

In accordance with a feature of the invention, the method can further include generating the ultrasound waves by at least one transmitter unit. The at least one transmitter can include at least one piezoelectric element.

According to another feature of the instant invention, the ultrasound waves can be received by at least one sensor receiver unit. The at least one sensor receiver unit can include at least one piezo-sensitive microphone.

Further, the wrapping strip may be acted on with ultrasound waves transversely to the transport direction.

The wrapping strip can be guided between a transmitter unit and a sensor receiver unit.

Moreover, the wrapping strip can be monitored over an entire width.

In accordance with still another feature, the acting on the wrapping strip with ultrasound waves can occur before the application of the glue.

According to the present invention, the determining can include evaluating the ultrasonic signals by an evaluation device.

In accordance with another feature of the invention, the determining may include averaging the ultrasonic signals in terms of time.

Moreover, the determining may include comparing the ultrasonic signals with one another. The comparing can include subtracting an ultrasonic signal after the application of glue from an ultrasonic signal before the application of the glue.

The determining may include detecting at least one of a quantity of glue lines of a glue pattern, and defective areas of the glue pattern. Further, the detecting of the quantity of the at least one of glue lines of a glue pattern can include time averaging, and the detecting of the defective areas is based upon ultrasonic signal received.

The instant invention is directed to a method for monitoring a glue pattern applied to a wrapping strip of the tobacco-processing industry. The method includes acting on the glue pattern with ultrasound waves receiving ultrasonic signals coming from the glue pattern, and monitoring the glue pattern based on the ultrasonic signals received.

The present invention is directed to a device for determining at least one of a quantity or mass of glue applied to a wrapping strip of the tobacco-processing industry. The device includes an ultrasound measuring system composed of at least one ultrasound generating source structured and arranged to act on the wrapping strip with ultrasound waves and at least one ultrasound sensor receiver unit structured and arranged to receive ultrasonic signals from the wrapping strip.

According to a feature of the invention, the wrapping strip may be guided through between the ultrasound generating source and the ultrasound sensor receiver unit.

Further, the ultrasound measuring system can be formed in a U-shaped manner. The at least one ultrasound generating source may be arranged in one branch of the U-shape and the at least one ultrasound sensor receiver unit is arranged in an other branch of the U-shape. The at least one ultrasound generating source may include at least one piezoelectric element, and the at least one ultrasound sensor receiver unit may include at least one piezo-sensitive microphone.

According to another feature of the instant invention, a second measuring system can be composed of a second ultrasound generating source and a second ultrasound sensor receiver unit. The second measuring system can be positioned before a glue application element for the wrapping strip, with respect to a transport direction of the wrapping strip. Furthers the second measuring system can be formed in a U-shape.

In accordance with a further feature of the invention, the device can include an evaluation device structured and arranged for evaluating the ultrasonic signals received.

Moreover, an entire width of the wrapping strip can be monitored by the ultrasound measuring system.

The invention is directed to a device for monitoring a glue pattern applied to a wrapping strip of the tobacco-processing industry. The device includes a sensor device composed of at least one ultrasound generating source, and at least one ultrasonic receiver unit. The at least one ultrasound generating unit can be structured and arranged to act on the glue pattern with ultrasound waves, and the at least one ultrasound receiver unit can be structured and arranged to receive ultrasonic signals from the glue pattern.

Further, the invention is directed to a machine of the tobacco-processing industry comprising a device for determining a quantity or mass of glue applied to a wrapping strip of the tobacco-processing industry as defined above.

The invention is directed to a process that includes determining at least one of a quantity or mass of glue applied to a wrapping strip of the tobacco-processing industry with a measuring system composed of an ultrasound measuring system.

In accordance with the present invention, the process can include monitoring the wrapping strip, while uncoated with glue, with a reference ultrasound measuring system.

In accordance with still yet another feature of the present invention, the process may include receiving, in an evaluation unit, the ultrasonic signals from the wrapping strip.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, wherein:

The FIGURE is a diagrammatic perspective illustration of a sensor according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The FIGURE shows an ultrasound measuring system 10 in a perspective view. The ultrasound measuring system 10 is embodied in the shape of a fork or U-shape. A tipping paper strip 15 is guided through and transported between the two branches of the U-shape. The tipping paper strip 15 is provided with a glue pattern of an applied glue that has been applied to the tipping paper strip 15 by a gluing element not shown here. The glue pattern has several areas 17 free of glue, which are perforated with the aid of processing elements after the tipping paper strip 15 has been cut into tipping webs and after the cut tipping webs have been wound around filter plugs and cut tobacco rods.

Furthermore, the tipping paper strip 15 has an edge area free of glue on both sides of the strip, typically in the order of magnitude of a width of 0.5 mm. The glue lines of the glue pattern in the edge zones in the area of the edge area free of glue have a typical width of approx. 4 mm and are provided with a glue layer 10 μm to 50 μm thick. In the center of the glue pattern the glue lines in the area of the central zones have a typical width of 4 mm to 10 mm and a glue line thickness of 10 μm to 30 μm thickness.

The edge zones are largely accountable for the adhesion of the tipping paper to the cut tobacco rod of the cigarette. A lack of glue at these areas leads to loose filters or filters falling off and is therefore particularly important for the application of the glue. In some places more glue is therefore applied in the edge zone area than in the central zones of the glue pattern.

In the event of gluing defects in the central zones, adhesion problems in the seam area of the filter can occur, which problems can be indirectly detected by a downstream pneumatic test system on a test drum, so that the cigarette provided with a defective tipping paper web is ejected. In the central zones there are continuous zones as well as zones free of glue (reference number 17).

Depending on the type of glue and the shape of the glue application element or other process parameters, increased amounts can occur within the individual glue lines and thus an inhomogeneous distribution of the glue over the width of the tipping paper strip 15.

The glued tipping paper strip 15 is guided through the U-shaped ultrasound measuring system 10 without contact. A guiding device or guide not shown here can be additionally provided in order to prevent paper web flutter. Located on the side uncoated with glue is a transmitting strip 13 with piezoelectric elements arranged in a linear manner to generate ultrasonic waves. A linear arrangement of sensors or piezo-sensitive microphones 14 is located on the opposite glued side of the tipping paper strip 15. The microphones 14 have, e.g., a width of approx. 2 mm to 5 mm and a spacing of approx. 0.2 mm to 0.6 mm.

The arrangement of the microphones 14 is adjusted to the ultrasonic frequency of the transmitting strip 13. Frequencies of over 100 kHz, preferably over 400 kHz, are typically suitable for determining the quantity of glue or monitoring the glue line or also the glue pattern on the tipping paper strip 15. The ultrasound generated by the piezoelectric elements of the transmitting strip 13 is hereby aligned transversely, in particular vertically, to the transport direction. The ultrasound generated permeates through the tipping paper strip 15 and the projecting edge zones of the tipping paper strip 15.

The ultrasound measuring system 10 works in pulsed operation, i.e., the transmitting strip 13 transmits a sound pulse so that the arrangement of the microphones 14 registers the intensity of the sound pressure received.

A different quantity or mass profile and density profile results over the width of the tipping paper strip 15 depending on the thickness or the base weight of the glue applied to the Upping paper strip 15. The quantity or mass or the density of the glue is measured over the width based on the amplitude changes of the receiver signal over the width of the tipping paper strip 15 detected by the microphones 14. The ultrasound measuring system 10 is connected to an evaluation device 20 for the evaluation of the ultrasonic signals received.

The transmitting strip 13 and the arrangement of the microphones 14 are designed such that they detect the glue pattern or the glue quantity over the entire width of the tipping paper strip 15. In particular they are designed so that they are longer than the maximum measure of a wrapping strip 15. Thus numerous widths of a tipping paper strip 15 can be detected with the same measuring system 10 format-free.

In order to eliminate effects of the tipping paper strip 15 on the measurements, a second ultrasound measuring system, which is likewise constructed in the manner of the ultrasound measuring system 10 shown in the drawings is arranged before the glue application element. This second ultrasound measuring system measures the fluctuations and effects of the thickness of a tipping paper strip 15 not yet glued. The second ultrasound measuring system is likewise connected to the evaluation device 20 so that a compensation of the paper thickness fluctuation takes place through a subtraction of the signals via the subtraction of the two ultrasonic signals measured before and after the gluing of the tipping paper strip 15.

The ultrasonic signals of the sensors are time averaged in order to be able to recognize the quantity or mass and quality of the gluing or its development over time or tendency over a longer period, and thus to draw conclusions about the adhesive force of the glue applied. Glue skips or defective areas of the glue pattern are recognized by exceeding or failing below a desired value for a predetermined glue quantity by means of the ultrasound measuring system 10 according to the invention.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

### LIST OF REFERENCE NUMBERS

10 Ultrasound measuring system
13 Transmitting strip
14 Microphones/sensor receiver unit
15 Tipping paper strip
17 Zones free of glue
20 Evaluation unit

What is claimed:

1. A method for determining at least one of a quantity or mass of glue applied to a wrapping strip of the tobacco-processing industry, comprising:
acting on the wrapping strip with ultrasound waves;
receiving the ultrasound waves permeating through the wrapping strip as ultrasonic signals; and
determining at least one of a quantity or mass of glue based on the ultrasonic signals received.

2. The method in accordance with claim 1, further comprising generating the ultrasound waves by at least one transmitter unit.

3. The method in accordance with claim 2, wherein the at least one transmitter comprises at least one piezoelectric element.

4. The method in accordance with claim 1, wherein the ultrasound waves are received by at least one sensor receiver unit.

5. The method in accordance with claim 4, wherein the at least one sensor receiver unit comprises at least one piezo-sensitive microphone.

6. The method in accordance with claim 1, wherein the wrapping strip is acted on with ultrasound waves transversely to the transport direction.

7. The method in accordance with claim 1, wherein the wrapping strip guided between a transmitter unit and a sensor receiver unit.

8. The method in accordance with claim 1, wherein the wrapping strip is monitored over an entire width.

9. The method in accordance with claim 1, wherein the acting on the wrapping strip with ultrasound waves occurs before the application of the glue.

10. The method in accordance with claim 1, wherein the determining comprises evaluating the ultrasonic signals by an evaluation device.

11. The method in accordance with claim 1, wherein the determining comprises averaging the ultrasonic signals in terms of time.

12. The method in accordance with claim 1, wherein the determining comprises comparing the ultrasonic signals with one another.

13. The method in accordance with claim 12, wherein the comparing comprises subtracting an ultrasonic signal after the application of glue from an ultrasonic signal before the application of the glue.

14. The method in accordance with claim 1, wherein the determining comprises detecting at least one of a quantity of glue lines of a glue pattern and defective areas of the glue pattern.

15. The method in accordance with claim 14, wherein the detecting of the quantity of the at least one of glue lines of a glue pattern comprises time averaging, and the detecting of the defective areas is based upon ultrasonic signal received.

16. A method for monitoring a glue pattern applied to a wrapping strip of the tobacco-processing industry, comprising:
acting on the glue pattern with ultrasound waves;
receiving ultrasonic signals coming from the glue pattern; and
monitoring the glue pattern based on the ultrasonic signals received.

17. A device for determining at least one of a quantity or mass of glue applied to a wrapping strip of the tobacco-processing industry, comprising:
an ultrasound measuring system composed of at least one ultrasound generating source structured and arranged to act on the wrapping strip with ultrasound waves and at least one ultrasound sensor receiver unit structured and arranged to receive ultrasonic signals from the wrapping strip.

18. The device in accordance with claim 17, wherein the wrapping strip is guided through between the ultrasound generating source and the ultrasound sensor receiver unit.

19. The device in accordance with claim 17, wherein the ultrasound measuring system is formed in a U-shaped manner.

20. The device in accordance with claim 19, wherein the at least one ultrasound generating source is arranged in one branch of the U-shape and the at least one ultrasound sensor receiver unit is arranged in an other branch of the U-shape.

21. The device in accordance with claim 20, wherein the at least one ultrasound generating source comprises at least one piezoelectric element, and the at least one ultrasound sensor receiver unit comprises at least one piezo-sensitive microphone.

22. The device in accordance with claim 17, further comprising a second measuring system composed of a second ultrasound generating source and a second ultrasound sensor receiver unit, wherein the second measuring system is positioned before a glue application element for the wrapping strip, with respect to a transport direction of the wrapping strip.

23. The device in accordance with claim 22, wherein the second measuring system is formed in a U-shape.

24. The device in accordance with claim 17, further comprising an evaluation device structured and arranged for evaluating the ultrasonic signals received.

25. The device in accordance with claim 17, wherein an entire width of the wrapping strip is monitored by the ultrasound measuring system.

26. A device for monitoring a glue pattern applied to a wrapping strip of the tobacco-processing industry, comprising:
a sensor device composed of at least one ultrasound generating source and at least one ultrasonic receiver unit.

27. The device in accordance with claim 26, wherein the at least one ultrasound generating unit is structured and arranged to act on the glue pattern with ultrasound waves, and the at least one ultrasound receiver unit is structured and arranged to receive ultrasonic signals from the glue pattern.

28. A machine of the tobacco-processing industry comprising a device for determining a quantity or mass of glue applied to a wrapping strip of the tobacco-processing industry in accordance with claim 26.

29. A process comprising:
determining at least one of a quantity or mass of glue applied to a wrapping strip of the tobacco-processing industry with a measuring system composed of an ultrasound measuring system.

30. The process in accordance with claim 29, further comprising monitoring the wrapping strip, while uncoated with glue, with a reference ultrasound measuring system.

31. The process in accordance with claim 29, further comprising receiving, in an evaluation unit, the ultrasonic signals from the wrapping strip.
